(19) United States
(12) Patent Application Publication
(10) Pub. No.: US 2024/0278600 A1
(43) Pub. Date: Aug. 22, 2024

(54) RUBBER COMPOSITION FOR TIRE

(71) Applicant: The Yokohama Rubber Co., Ltd., Kanagawa (JP)

(72) Inventor: Rei KAWAGUCHI, Kanagawa (JP)

(21) Appl. No.: 18/567,439

(22) PCT Filed: Mar. 15, 2022
(86) PCT No.: PCT/JP2022/011627

§ 371 Date: Dec. 6, 2023

(30) Foreign Application Priority Data
Jun. 11, 2021 (JP) 2021-097864

(51) Int. Cl. B60C 1/00; B60C 11/00; C08C 19/25; C08K 3/36; C08K 5/098; C08K 5/5419; C08K 5/548; C08L 53/02

(52) U.S. Cl. CPC B60C 1/0016; B60C 11/005; C08C 19/25; C08K 3/36; C08K 5/098; C08K 5/5419; C08K 5/548; C08L 53/02; C08K 2201/006

(57) ABSTRACT

A rubber composition for a tire contains a diene rubber, silica, a silane coupling agent, a fatty acid metal salt, and an alkylsilane. 60-95 mass % of a specific conjugated diene rubber is used as the diene rubber and is formed by reacting a polyorganosiloxane with an active terminal of a conjugated diene-based polymer chain having the active terminal and by making a polymer block A continuous with a polymer block B. The polymer block A contains 80-95 mass % of isoprene and 5-20 mass % of aromatic vinyl, has an active terminal, and has a weight average molecular weight of 500-15000. The polymer block B contains 1,3-butadiene and an aromatic vinyl and has an active terminal. 55-90 parts by mass of silica having a CTAB adsorption specific surface area of 185 m²/g or more is used as the silica.

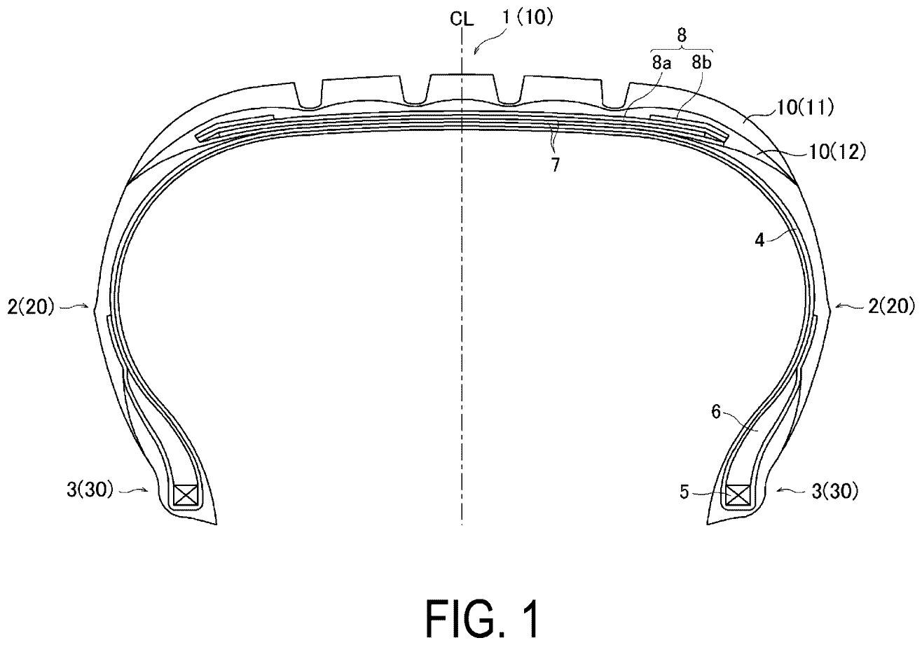

### TECHNICAL FIELD

The present technology relates to a rubber composition for a tire, which is intended mainly for use in a cap tread of a tire.

### BACKGROUND ART

In recent years, there has been a demand to reduce tire rolling resistance from the perspective of fuel efficiency when a vehicle is traveling. Further, in terms of safety, improvement of wet performance (braking performance on wet road surfaces) is demanded. In response to such demands, in a known method, silica is blended to a rubber component constituting a tread portion of a tire to provide low rolling resistance and wet performance in a compatible manner. However, silica has low affinity with a rubber component, and the cohesiveness between silica components is high, so if silica is simply blended with the rubber component, the silica is not dispersed, and thus, unfortunately, the effect of reducing the rolling resistance or the effect of improving the wet performance cannot be sufficiently achieved. Thus, a combined use with a silane coupling agent having high dispersibility has been considered as in, for example, Japan Unexamined Patent Publication No. 2017-141405 A. However, in a case where a silane coupling agent is used in combination, strength at break may decrease and thus wear resistance may not be necessarily adequately achieved, and fuel economy performance, wet performance, and wear resistance performance may not be provided in a well-balanced and compatible manner. Thus, further measures have been demanded to provide these performances in a well-balanced and compatible manner to a high degree.

### SUMMARY

The present technology provides a rubber composition for a tire that can provide fuel economy performance, wet performance, and wear resistance performance in a well-balanced and compatible manner.

The rubber composition for a tire of an aspect of the present technology comprises a diene rubber, silica, a silane coupling agent, a fatty acid metal salt, and an alkylsilane. The diene rubber contains from 60 mass % to 95 mass % of a specific conjugated diene rubber. The specific conjugated diene rubber is formed by reacting a polyorganosiloxane with an active terminal of a conjugated diene-based polymer chain having the active terminal. The conjugated diene-based polymer chain is formed by making a polymer block A continuous with a polymer block B. The polymer block A contains from 80 mass % to 95 mass % of isoprene and from 5 mass % to 20 mass % of aromatic vinyl, has an active terminal, and has a weight average molecular weight of from 500 to 15000. The polymer block B contains 1,3-butadiene and an aromatic vinyl and has an active terminal. The silica has a CTAB (cetyltrimethylammonium bromide) adsorption specific surface area of 185 m²/g or more. A blended amount of the silica is from 55 parts by mass to 90 parts by mass with respect to 100 parts by mass of the diene rubber.

The rubber composition for a tire of an embodiment of the present technology can improve wet performance by blending of the silica having a small particle size as described above. Furthermore, because the fatty acid metal salt and the alkylsilane are used in combination in addition to the silane coupling agent when the silica is blended, improvement of fuel economy performance and wear resistance performance can be attempted in addition to improvement of wet performance due to the silica. Furthermore, also when the diene rubber contains the specific conjugated diene rubber, dispersibility of the silica can be improved. Due to these synergistic effects, fuel economy performance, wet performance, and wear resistance performance can be provided in a well-balanced and compatible manner to a high degree. In an embodiment of the present technology, the “CTAB adsorption specific surface area” is measured in accordance with ISO (International Organization for Standardization) 5794.

In the rubber composition for a tire of an embodiment of the present technology, the diene rubber preferably contains from 5 mass % to 40 mass % of the poly butadiene rubber. Accordingly, the glass transition temperature of the rubber composition can be reduced, which is advantageous to improve wear resistance.

In the rubber composition for a tire of an embodiment of the present technology, the silane coupling agent preferably contains a tetrasulfide bond in a molecule. Furthermore, the blended amount of the fatty acid metal salt is preferably from 2 mass % to 8 mass % with respect to the blended amount of the silica. Furthermore, the blended amount of the alkoxysilane is preferably from 0.1 mass % to 20 mass % with respect to the blended amount of the silica.

The rubber composition for a tire of an embodiment of the present technology can be used in a tread portion of a tire. In particular, the rubber composition for a tire of an embodiment of the present technology is preferably used for a cap tread in a tire that includes a tread portion extending in a tire circumferential direction and having an annular shape, a cap tread constituting a road contact surface of the tread portion, and the undertread disposed on an inner circumferential side thereof. At this time, a hardness difference between the undertread and the cap tread in terms of JIS (Japanese Industrial Standard)-A hardness is preferably 5 or less. Accordingly, wet performance can be improved while good steering stability is maintained. Note that, in an embodiment of the present technology, “JIS-A hardness” is the durometer hardness measured at a temperature of 20° C. in accordance with JIS-K6253 using a type A durometer.

The tire according to an embodiment of the present technology is preferably a pneumatic tire, but may be a non-pneumatic tire. In a case of a pneumatic tire, the interior thereof can be filled with air, inert gas such as nitrogen, or other gases.

### BRIEF DESCRIPTION OF DRAWINGS

The Drawing is a meridian cross-sectional view illustrating an example of a pneumatic tire using a rubber composition for a tire according to an embodiment of the present technology.

### DETAILED DESCRIPTION

Configurations of embodiments of the present technology will be described in detail below with reference to the accompanying drawings.

As illustrated in the Drawing, a pneumatic tire using a rubber composition for a tire according to an embodiment of the present technology includes a tread portion 1, a pair of sidewall portions 2 respectively disposed on both sides of the tread portion 1, and a pair of bead portions 3 each disposed on an inner side of the pair of sidewall portions 2 in a tire radial direction. “CL” in the Drawing denotes a tire equator. Although not illustrated in the Drawing, which is a meridian cross-sectional view, the tread portion 1, the sidewall portions 2, and the bead portions 3 each extend in a tire circumferential direction and have an annular shape. This forms a toroidal basic structure of the pneumatic tire. Although the description using the Drawing is basically based on the illustrated meridian cross-sectional shape, all of the tire components extend in the tire circumferential direction and form the annular shape.

A carcass layer 4 is mounted between the left-right pair of bead portions 3. The carcass layer 4 includes a plurality of reinforcing cords extending in the tire radial direction and is folded back around a bead core 5 disposed in each of the bead portions 3 from a vehicle inner side to a vehicle outer side. Additionally, a bead filler 6 is disposed on the periphery of the bead core 5, and the bead filler 6 is enveloped by a body portion and a folded back portion of the carcass layer 4. On the other hand, in the tread portion 1, a plurality of belt layers 7 (two layers in the Drawing) are embedded on an outer circumferential side of the carcass layer 4. The belt layers 7 each include a plurality of reinforcing cords inclining with respect to the tire circumferential direction and are disposed such that the reinforcing cords of the different layers intersect each other. In these belt layers 7, the inclination angle of the reinforcing cords with respect to the tire circumferential direction is set in a range of, for example, from 10° to 40°. Moreover, a belt reinforcing layer 8 (two layers including a full cover 8a covering the entire width of the belt layer 7 and an edge cover 8b locally covering an end of the belt layer 7) is provided on an outer circumferential side of the belt layer 7. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°.

A tread rubber layer 10 is disposed on the outer circumferential side of the carcass layer 4 in the tread portion 1. A side rubber layer 20 is disposed on the outer circumferential side (outward in the tire lateral direction) of the carcass layer 4 in each of the sidewall portions 2. A rim cushion rubber layer 30 is disposed on the outer circumferential side (outward in the tire lateral direction) of the carcass layer 4 in each of the bead portions 3. The tread rubber layer 10 has a structure in which two types of rubber layers having different physical properties (a cap tread 11 constituting a road contact surface of the tread portion 1 and an undertread 12 disposed on an inner circumferential side of the cap tread 11) are stacked in the tire radial direction.

The rubber composition for a tire according to an embodiment of the present technology is mainly used for the cap tread 11 of the tire as described above. Thus, in the tire to which the rubber composition for a tire of an embodiment of the present technology is used, as long as the tread portion 1 (tread rubber layer 10) includes the cap tread 11 and the undertread 12, a basic structure of other portions is not limited to the above-described structure.

In the rubber composition for a tire of an embodiment of the present technology, the rubber component is a diene rubber and always contains a specific conjugated diene rubber described below. The proportion of the specific conjugated diene rubber is from 60 mass % to 95 mass %, and preferably from 70 mass % to 85 mass %, with respect to 100 mass % of the diene rubber. By allowing the specific conjugated diene rubber to be contained, dispersibility of the silica described below can be improved, and fuel efficiency can be improved. When the blended amount of the specific conjugated diene rubber is less than 60 mass %, wet performance deteriorates. When the blended amount of the specific conjugated diene rubber is more than 98 mass %, fuel efficiency and wear resistance deteriorate.

The specific conjugated diene rubber is a conjugated diene rubber formed by reacting a polyorganosiloxane with an active terminal of a conjugated diene-based polymer chain having the active terminal. The conjugated diene-based polymer chain is formed by making a polymer block A continuous with a polymer block B. The polymer block A contains from 80 mass % to 95 mass % of isoprene and from 5 mass % to 20 mass % of aromatic vinyl, has an active terminal, and has a weight average molecular weight of from 500 to 15000. The polymer block B contains 1,3-butadiene and an aromatic vinyl and has an active terminal.

Examples of the aromatic vinyl in the polymer block A include styrene, α-methylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethylstyrene, 4-t-butylstyrene, 5-t-butyl-2-methylstyrene, vinylnaphthalene, dimethylaminomethylstyrene, and dimethylaminoethylstyrene. Among these, styrene is preferred. Such aromatic vinyl may be used alone, or a combination of two or more types may be used.

The weight average molecular weight (Mw) of the polymer block A is from 500 to 15000, preferably from 1000 to 12000, more preferably from 1500 to 10000, as described above. When the weight average molecular weight of the polymer block A is less than 500, the desired low rolling performance and wet performance are less likely to be expressed. When the weight average molecular weight of the polymer block A exceeds 15000, the balance of viscoelastic properties, which is an index of desired low rolling performance and wet performance, may be lost. The weight average molecular weight is a value measured by gel permeation chromatography (GPC) based on calibration with polystyrene.

The content of the isoprene unit content in the polymer block A is preferably from 80 to 95 mass %, preferably from 85 to 95 mass %, and more preferably from 87 mass % to 95 mass %. The aromatic vinyl content in the polymer block A is preferably from 5 to 20 mass %, preferably from 5 to 15 mass %, and more preferably from 5 to 13 mass %, as described above.

The polymer block A may contain monomer units other than isoprene and aromatic vinyl, but the content of monomer units other than isoprene and aromatic vinyl is preferably 15 mass % or less, more preferably 10 mass % or less, and more preferably 6 mass % or less. Examples of monomer units other than isoprene and aromatic vinyl include conjugated dienes other than isoprene such as 1,3-butadiene, 2,3-dimethyl-1,3-butadiene, 2-chloro-1,3-butadiene, 1,3-pentadiene, and 1,3-hexadiene: α- and β-unsaturated nitriles such as acrylonitrile and methacrylonitrile: unsaturated carboxylic acids or acid anhydrides such as acrylic acid, methacrylic acid, and maleic anhydride; unsaturated carboxylic acid esters such as methylmethacrylate, ethylacrylate, and butylacrylate; and non-conjugated dienes such as 1,5-hexadiene, 1,6-heptadiene, 1,7-octadiene, dicyclopentadiene, and 5-ethylidene-2-norbornene.

The specific examples and suitable aspects of the aromatic vinyl in the polymer block B are identical to those of the polymer block A and as described above. The 1,3-butadiene unit content in the polymer block B is not particularly limited, but is preferably from 55 mass % to 95 mass %, and more preferably from 55 mass % to 90 mass %. The aromatic vinyl unit content in the polymer block B is not particularly limited, but is preferably from 5 mass % to 45 mass %, and more preferably from 10 mass % to 45 mass %.

The polymer block B may have monomer units other than the 1,3-butadiene unit and aromatic vinyl unit. Examples of other monomers used to constitute other monomer units include those excluding 1,3-butadiene among “examples other than aromatic vinyl among monomers other than isoprene” described above, and isoprene. The content of the other monomer units in the polymer block B is preferably 50 mass % or less, more preferably 40 mass % or less, and further preferably 35 mass % or less.

The conjugated diene-based polymer chain having the active terminal formed by making the polymer block A continuous with the polymer block B is, from the perspective of productivity, constituted by (the polymer block A)-(the polymer block B), and the terminal of the polymer block B is preferably an active terminal. However, the conjugated diene-based polymer chain may have a plurality of polymer blocks A or may have other polymer blocks. Examples thereof include conjugated diene-based polymer chains having an active terminal, such as blocks composed only of (the polymer block A)-(the polymer block B)-(the polymer block A) and of (the polymer block A)-(the polymer block B)-isoprene. The mass ratio of the polymer block A to the polymer block B in the conjugated diene-based polymer chain having an active terminal described above (when there are a plurality of polymer blocks A and B, based on each total mass) is preferably from 0.001 to 0.1, more preferably from 0.003 to 0.07, and further preferably from 0.005 to 0.05, as (mass of the polymer block A)/(mass of the polymer block B).

The polyorganosiloxane is represented by Formula (1) below. In Formula (1) below, R₁ to R₈ are alkyl groups having from 1 to 6 carbons or aryl groups having from 6 to 12 carbons and may be the same or different from each other. X₁ and X₄ are groups selected from the group consisting of alkyl groups having from 1 to 6 carbons, aryl groups having 6 to 12 carbons, alkoxy groups having 1 to 5 carbons, and epoxy group-containing groups having from 4 to 12 carbons and may be the same or different from each other. X₂ is an alkoxy group having from 1 to 5 carbons or an epoxy group-containing group having from 4 to 12 carbons, and the plurality of X₂ groups may be the same or different from each other. X₃ is a group containing 2 to 20 alkylene glycol repeating units, and, when there are a plurality of X₃ groups, they may be the same or different from each other. m is an integer from 3 to 200, n is an integer from 0 to 200, and k is an integer from 0 to 200.

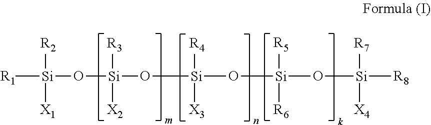

In the rubber composition for a tire of an embodiment of the present technology, in addition to the specific conjugated diene rubber described above, a poly butadiene rubber can be blended as the rubber component. When a polybutadiene rubber is used in combination, the blended amount thereof is preferably from 5 mass % to 40 mass %, and more preferably from 15 mass % to mass %, with respect to 100 mass % of the diene rubber. Combined use of the polybutadiene rubber in this manner can reduce the glass transition temperature of the rubber composition and thus is advantageous to improve wear resistance. When the blended amount of the poly butadiene rubber is less than 5 mass %, wear resistance deteriorates. When the blended amount of the polybutadiene rubber is more than 40 mass %, wet performance deteriorates.

When the rubber component contains a polybutadiene rubber, the poly butadiene rubber is preferably a modified poly butadiene rubber. Use of the modified poly butadiene rubber is advantageous to make rolling resistance low. The modified poly butadiene rubber preferably contains a functional group that is reactive with silica. Examples of such a functional group include a hydroxy group, a hydroxy silyl group, an alkoxy group, a carboxy group, and an amino group. The modified poly butadiene rubber may be produced by an ordinary method or may be appropriately selected from commercially available products for use.

In the rubber composition for a tire of an embodiment of the present technology, silica is always blended as a filler for the diene rubber described above. The silica used in an embodiment of the present technology has a CTAB adsorption specific surface area of 185 m²/g or more, and preferably from 190 m²/g to 210 m²/g. When such silica having a small particle size is used, wet performance can be improved. The silica that is used may be a silica that is ordinarily used in rubber compositions for tires such as, for example, wet silica, dry silica, surface-treated silica, or the like. The silica may be appropriately selected from commercially available products. Silica obtained by a normal manufacturing method can also be used.

The blended amount of the silica is from 55 parts by mass to 90 parts by mass, and preferably from 70 parts by mass to 80 parts by mass, with respect to 100 parts by mass of the diene rubber described above. Blending of an appropriate amount of the silica as described above is advantageous to provide fuel economy performance, wet performance, and wear resistance performance in a well-balanced and compatible manner. When the blended amount of the silica is less than 55 parts by mass, wear resistance deteriorates. When the blended amount of the silica is more than 90 parts by mass, fuel efficiency deteriorates.

The rubber composition of an embodiment of the present technology may contain a filler other than the silica. Examples of such inorganic fillers include materials typically used for a rubber composition for a tire, such as carbon black, clay, talc, calcium carbonate, mica, and aluminum hydroxide.

In the rubber composition for a tire of an embodiment of the present technology, a silane coupling agent is always used in combination when the silica described above is blended. Blending a silane coupling agent can improve dispersibility of the silica in the diene rubber. The type of the silane coupling agent is not particularly limited as long as it is a silane coupling agent that can be used in a rubber composition containing silica. Examples thereof include a sulfur-containing silane coupling agent, such as bis(3-triethoxysilylpropyl)tetrasulfide, bis(3-triethoxysilylpropyl)disulfide, 3-trimethoxysilylpropyl benzothiazole tetrasulfide, γ-mercaptopropyl triethoxysilane, and 3-octanoylthiopropyl triethoxysilane. Among these, a silane coupling agent containing a tetrasulfide bond in a molecule can be particularly preferably used. The blended amount of the silane coupling agent is preferably 15 mass % or less, and more preferably from 3 mass % to 12 mass %, with respect to the blended amount of the silica. When the blended amount of the silane coupling agent is greater than 15 mass % with respect to the blended amount of the silica, the silane coupling agent condenses, and thereby desired hardness and strength of the rubber composition are failed to achieve.

In the rubber composition for a tire of an embodiment of the present technology, an alkylsilaneis always blended as a plasticizer component when the silica described above is blended. When the alkylsilane is blended, aggregation of silica and viscosity increase in the rubber composition can be suppressed, and excellent rolling resistance and wet performance can be achieved. Examples of the alkylsilane include monoalkyltrialkoxysilane, dialkyldialkoxysilane, and trialkylmonoalkoxysilane. Among these, alkyltrialkoxysilane is preferred, and alkyltriethoxy silane is more preferred. As the alkyltriethoxysilane, an alkyltriethoxysilane containing an alkyl group having from 7 to 20 carbons is preferred. Examples of the alkyl group having from 7 to 20 carbons include a heptyl group, octyl group, nonyl group, decyl group, undecyl group, dodecyl group, tridecyl group, tetradecyl group, pentadecyl group, hexadecyl group, heptadecyl group, octadecyl group, nonadecyl group, and icosyl group. Among these, from the perspective of miscibility with the diene rubber, an alkyl group having from 8 to 10 carbons is preferable, and an octyl group or nonyl group is even more preferable. The blended amount of the alkylsilane is preferably from 0.1 mass % to 20 mass %, and more preferably from 1 mass % to 5 mass %, with respect to the mass of the silica. When the blended amount of the alkylsilane is less than 0.1 mass %, rolling resistance deteriorates. When the blended amount of the alkylsilane is more than 20 mass %, wet grip deteriorates.

In the rubber composition for a tread of an embodiment of the present technology, a fatty acid metal salt as a plasticizer component is always blended. When the fatty acid metal salt is blended, aggregation of silica and viscosity increase in the rubber composition can be suppressed, and excellent rolling resistance and wet performance can be achieved. Examples of the fatty acid metal salt include various fatty acids such as caprylic acid, undecylenic acid, lauryl acid, myristic acid, palmitic acid, margaric acid, stearic acid, alginic acid, lignoceric acid, cerotic acid, melissic acid, myristoleic acid, oleic acid, linoleic acid, and linolenic acid, and a salt of alkali metal such as lithium, sodium, and potassium. A single type or a combination of multiple types of fatty acid metal salts can be blended. The blended amount of the fatty acid metal salt is preferably from 2 mass % to 8 mass %, and more preferably from 3 mass % to 6 mass %, with respect to the mass of the silica. When the blended amount of the fatty acid metal salt is less than 2 mass %, rolling resistance deteriorates. When the blended amount of the fatty acid metal salt is more than 8 mass %, wet grip deteriorates.

In the rubber composition according to an embodiment of the present technology, compounding agents other than those above may also be added. Examples of such other compounding agents include various compounding agents generally used in rubber compositions for tires, such as vulcanizing or crosslinking agents, vulcanization accelerators, anti-aging agents, liquid polymers, thermosetting resins, and thermoplastic resins. These compounding agents can be blended in typical amounts in the related art so long as the present technology is not hindered. As a kneader, a typical kneader for a rubber, such as a Banbury mixer, a kneader, or a roller, may be used.

Since the rubber composition for a tire of an embodiment of the present technology is mainly used for the cap tread 11, the blend of the rubber composition constituting the undertread 12 to be used in combination when used in the tire is not particularly limited. However, the cap tread 11 containing the rubber composition for a tire of an embodiment of the present technology preferably has a higher hardness than that of the undertread 12, and the hardness difference between the cap tread 11 and the undertread 12 is preferably 5 or less, and more preferably 3 or less, in terms of JIS-A hardness. When the hardness difference from the undertread 12 is adequately made small as described above when the rubber composition for a tire of an embodiment of the present technology is used in the cap tread 11, wet performance can be improved while good steering stability is maintained. When the hardness difference between the cap tread 11 and the undertread 12 is too large, it becomes difficult to maintain good steering stability. Note that the hardness of the undertread 12 of the rubber composition for a tire of an embodiment of the present technology is not particularly limited and can be set to, for example, from 56 to 63 in terms of JIS-A hardness.

The present technology will further be described below by way of Examples, but the scope of the present technology is not limited to Examples.

### EXAMPLE

To prepare 14 types of rubber compositions for tires each containing the blend listed in Table 1 (Conventional Example 1, Comparative Examples 1 to 7, and Examples 1 to 6), components other than the sulfur and the vulcanization accelerator were kneaded in a 1.7 L Banbury mixer for 5 minutes, and when the temperature reached 145° C., the mixture was discharged and used as a master batch. To the resulting master batch, the sulfur and the vulcanization accelerator were added and kneaded in an open roll at 70° ° C., and thus each rubber composition for a tire was produced.

A test piece produced by vulcanizing (vulcanization temperature: 160° C.: vulcanization time: 20 minutes) the resulting rubber composition for a tire into a shape of a Lupke sample (cylindrical shape having a thickness of 12.5 mm and a diameter of 29 mm) was prepared. Using the resulting test piece, rubber hardness at a temperature of 20° C. was measured by a type A durometer in accordance with JIS K6253, and the hardness difference relative to the hardness of the undertread was calculated. The hardness difference is shown in the row of “Hardness difference” in Table 1. Note that, in all of the examples, a common rubber was used for the undertread, a test piece described above was also prepared for the undertread, the hardness was measured by the same method, and then a value calculated by subtracting the hardness of the cap tread from the hardness of the undertread was used as the hardness difference.

A pneumatic tire (test tire) having a tire size of 235/60R18 and having a basic structure illustrated in the Drawing was produced by using each of the obtained rubber compositions for tires (Conventional Example 1, Comparative Examples 1 to 7, and Examples 1 to 6) in each tread rubber. Note that parts other than the tread rubber were common for all of the test tires. For each of the test tires, wet performance, fuel economy performance, and wear resistance performance were evaluated by the following methods.

### Wet Performance

Each of the test tires was assembled on a wheel having a rim size of 18×7.5 J, inflated to an air pressure of 230 kPa, and mounted on a test vehicle having an engine displacement of 2500 cc. A braking distance from a speed of 100 km/h on a wet road surface was measured. The evaluation results are expressed as index values using the reciprocal of the measurement values, with the Conventional Example 1 being assigned the index value of 100. Larger index values indicate shorter braking distance and superior wet performance.

### Fuel Economy Performance

Each test tire was mounted on a wheel having a rim size of 18×7.5 J and inflated to an air pressure of 210 kPa. Using an indoor drum testing machine (drum diameter: 1707 mm), rolling resistance was measured when the tire was driven at a speed of 80 km/h while pushed against the drum under a load equivalent to 85% of the maximum load at the air pressure described in the 2009 JATMA (The Japan Automobile Tyre Manufacturers Association Inc.) Year Book. The evaluation results were expressed as index values using the reciprocal of the measurement values, with the Conventional Example 1 being assigned the index of 100. A larger index value indicates lower rolling resistance and superior fuel economy performance.

### Wear Resistance Performance

Each of the test tires was assembled on a wheel having a rim size of 18×7.5 J, inflated to an air pressure of 230 kPa, and mounted on a test vehicle having an engine displacement of 2500 cc. A wear resistance was measured by measuring a groove depth after traveling for 20000 km on a dry road surface was performed. Evaluation results are expressed as index values with Conventional Example 1 being assigned the value of 100. Larger index values indicate superior wear resistance.

TABLE 1

| | | Conven- | | Compar- | Compar- |
|---|---|---|---|---|---|
| | | tional | Exam- | ative | ative |
| | | Example 1 | ple 1 | Example 1 | Example 2 |
| Conjugated | Parts by | | 70 | 50 | 100 |
| diene rubber 1 | mass | | | | |
| Conjugated | Parts by | 70 | | | |
| diene rubber 2 | mass | | | | |
| BR 1 | Parts by | 30 | 30 | 50 | |
| | mass | | | | |
| BR 2 | Parts by | | | | |
| | mass | | | | |
| CB | Parts by | 10 | 10 | 10 | 10 |
| | mass | | | | |
| Silica 1 | Parts by | 60 | | | |
| | mass | | | | |
| Silica 2 | Parts by | | 55 | 60 | 60 |
| | mass | | | | |
| Silane | Parts by | 6 | 5.5 | 6 | 6 |
| coupling agent | mass | | | | |
| Alkylsilane | Parts by | | 5 | 5 | 5 |
| | mass | | | | |
| Fatty acid | Parts by | | 3 | 3 | 3 |
| metal salt | mass | | | | |
| Aroma oil | Parts by | 10 | 5 | 5 | 5 |
| | mass | | | | |
| Anti-aging agent | Parts by | 2 | 2 | 2 | 2 |
| | mass | | | | |
| Wax | Parts by | 1 | 1 | 1 | 1 |
| | mass | | | | |
| Zinc oxide | Parts by | 2 | 2 | 2 | 2 |
| | mass | | | | |
| Stearic acid | Parts by | 2 | 2 | 2 | 2 |
| | mass | | | | |
| Vulcanization | Parts by | 2 | 2 | 2 | 2 |
| accelerator | mass | | | | |
| Sulfur | Parts by | 1.5 | 1.5 | 1.5 | 1.5 |
| | mass | | | | |
| Hardness | | 10 | 3 | 3 | 3 |
| difference | | | | | |
| Wet performance | Index | 100 | 103 | 97 | 110 |
| | value | | | | |
| Fuel economy | Index | 100 | 107 | 110 | 97 |
| performance | value | | | | |
| Wear resistance | Index | 100 | 103 | 108 | 97 |
| performance | value | | | | |

| | | Comparative | Comparative | Comparative |
|---|---|---|---|---|
| | | Example 3 | Example 4 | Example 5 |
| Conjugated | Parts by | 70 | 70 | 70 |
| diene rubber 1 | mass | | | |
| Conjugated | Parts by | | | |
| diene rubber 2 | mass | | | |
| BR 1 | Parts by | 30 | 30 | 30 |
| | mass | | | |
| BR 2 | Parts by | | | |
| | mass | | | |
| CB | Parts by | 10 | 10 | 10 |
| | mass | | | |
| Silica 1 | Parts by | 55 | | |
| | mass | | | |
| Silica 2 | Parts by | | 50 | 100 |
| | mass | | | |
| Silane | Parts by | 5.5 | 5 | 10 |
| coupling agent | mass | | | |
| Alkylsilane | Parts by | 5 | 5 | 5 |
| | mass | | | |
| Fatty acid | Parts by | 3 | 3 | 3 |
| metal salt | mass | | | |
| Aroma oil | Parts by | 5 | 5 | 5 |
| | mass | | | |
| Anti-aging agent | Parts by | 2 | 2 | 2 |
| | mass | | | |
| Wax | Parts by | 1 | 1 | 1 |
| | mass | | | |
| Zinc oxide | Parts by | 2 | 2 | 2 |
| | mass | | | |
| Stearic acid | Parts by | 2 | 2 | 2 |
| | mass | | | |
| Vulcanization | Parts by | 2 | 2 | 2 |
| accelerator | mass | | | |
| Sulfur | Parts by | 1.5 | 1.5 | 1.5 |
| | mass | | | |
| Hardness | | 3 | 1 | 12 |
| difference | | | | |
| Wet performance | Index | 97 | 102 | 105 |
| | value | | | |
| Fuel economy | Index | 107 | 109 | 96 |
| performance | value | | | |
| Wear resistance | Index | 103 | 97 | 108 |
| performance | value | | | |

| | | Comparative | Comparative | |
|---|---|---|---|---|
| | | Example 6 | Example 7 | Example 2 |
| Conjugated | Parts by | 70 | 70 | 70 |
| diene rubber 1 | mass | | | |
| Conjugated | Parts by | | | |
| diene rubber 2 | mass | | | |
| BR 1 | Parts by | 30 | 30 | 30 |
| | mass | | | |
| BR 2 | Parts by | | | |
| | mass | | | |
| CB | Parts by | 10 | 10 | 10 |
| | mass | | | |
| Silica 1 | Parts by | | | |
| | mass | | | |
| Silica 2 | Parts by | 60 | 60 | 70 |
| | mass | | | |
| Silane | Parts by | 6 | 6 | 7 |
| coupling agent | mass | | | |
| Alkylsilane | Parts by | 5 | | 5 |
| | mass | | | |
| Fatty acid | Parts by | | 3 | 3 |
| metal salt | mass | | | |
| Aroma oil | Parts by | 5 | 10 | 5 |
| | mass | | | |
| Anti-aging agent | Parts by | 2 | 2 | 2 |
| | mass | | | |
| Wax | Parts by | 1 | 1 | 1 |
| | mass | | | |
| Zinc oxide | Parts by | 2 | 2 | 2 |
| | mass | | | |
| Stearic acid | Parts by | 2 | 2 | 2 |
| | mass | | | |
| Vulcanization | Parts by | 2 | 2 | 2 |
| accelerator | mass | | | |
| Sulfur | Parts by | 1.5 | 1.5 | 1.5 |
| | mass | | | |
| Hardness | | 3 | 3 | 3 |
| difference | | | | |
| Wet performance | Index | 96 | 96 | 104 |
| | value | | | |
| Fuel economy | Index | 97 | 97 | 104 |
| performance | value | | | |
| Wear resistance | Index | 100 | 100 | 105 |
| performance | value | | | |

| | | Exam- | Exam- | Exam- | Exam- |
|---|---|---|---|---|---|
| | | ple 3 | ple 4 | ple 5 | ple 6 |
| Conjugated | Parts by | 70 | 60 | 95 | 70 |
| diene rubber 1 | mass | | | | |
| Conjugated | Parts by | | | | |
| diene rubber 2 | mass | | | | |
| BR 1 | Parts by | 30 | 40 | 5 | |
| | mass | | | | |
| BR 2 | Parts by | | | | 30 |
| | mass | | | | |
| CB | Parts by | 10 | 10 | 10 | 10 |
| | mass | | | | |
| Silica 1 | Parts by | | | | |
| | mass | | | | |
| Silica 2 | Parts by | 90 | 60 | 60 | 55 |
| | mass | | | | |
| Silane | Parts by | 9 | 6 | 6 | 5.5 |
| coupling agent | mass | | | | |
| Alkylsilane | Parts by | 5 | 3 | 3 | 5 |
| | mass | | | | |
| Fatty acid | Parts by | 3 | 3 | 3 | 3 |
| metal salt | mass | | | | |
| Aroma oil | Parts by | 5 | 5 | 5 | 5 |
| | mass | | | | |
| Anti-aging agent | Parts by | 2 | 2 | 2 | 2 |
| | mass | | | | |
| Wax | Parts by | 1 | 1 | 1 | 1 |
| | mass | | | | |
| Zinc oxide | Parts by | 2 | 2 | 2 | 2 |
| | mass | | | | |
| Stearic acid | Parts by | 2 | 2 | 2 | 2 |
| | mass | | | | |
| Vulcanization | Parts by | 2 | 2 | 2 | 2 |
| accelerator | mass | | | | |
| Sulfur | Parts by | 1.5 | 1.5 | 1.5 | 1.5 |
| | mass | | | | |
| Hardness | | 5 | 3 | 3 | 3 |
| difference | | | | | |
| Wet performance | Index | 105 | 101 | 108 | 104 |
| | value | | | | |
| Fuel economy | Index | 101 | 109 | 101 | 108 |
| performance | value | | | | |
| Wear resistance | Index | 107 | 106 | 101 | 103 |
| performance | value | | | | |

Types of raw materials used indicated in Table 1 are described below.
Conjugated diene rubber 1: NS560, available from Zeon Corporation
Conjugated diene rubber 2: NS540, available from Zeon Corporation
BR 1: Polybutadiene rubber, Nipol BR1220, available from Zeon Corporation
BR 2: Polybutadiene rubber, BR54, available from JSR Corporation
CB: Carbon black, SEAST KHA, available from Tokai Carbon Co., Ltd.
Silica 1: ZEOSIL 1165MP, available from Solvay (CTAB adsorption specific surface area: 156 m²/g)
Silica 2: ULTRASIL 9100GR, available from Evonik (CTAB adsorption specific surface area: 202 m²/g)
Silane coupling agent: KBE-846, available from Shin-Etsu Chemical Co., Ltd.
Alkylsilane: Alkyltriethoxysilane (n-octyltriethoxysilane), KBE-3083, available from Shin-Etsu Chemical Co., Ltd.
Fatty acid metal salt: HT207, available from Struktol Company
Aroma oil: Diana Process NH-70S, available from Idemitsu Kosan Co., Ltd.
Anti-aging agent: VULKANOX 4020, available from Lanxess AG
Wax: OZOACE-0015A, available from Nippon Seiro Co., Ltd.
Zinc oxide: Zinc oxide, available from ZM Silesia S.A.
Stearic acid: PALMAC 1600, available from IOI Acidchem Sdn Bhd
Vulcanization accelerator: NOCCELER TOT-N, available from Ouchi Shinko Chemical Industrial Co., Ltd.
Sulfur: SULFAX 5, available from Tsurumi Chemical Industry Co., Ltd.

As is clear from Table 1, for the tires of Examples 1 to 6, the wet performance, the fuel economy performance, and the wear resistance performance were improved compared to those of Conventional Example 1, and these performances were provided in a well-balanced and compatible manner. On the other hand, the tire of Comparative Example 1 had a small blended amount of the specific conjugated diene rubber 1, and thus the wet performance deteriorated. The tire of Comparative Example 2 had a large blended amount of the specific conjugated diene rubber 1, and thus the fuel economy performance and the wear resistance performance deteriorated. The tire of Comparative Example 3 had a large particle size of the silica, and thus the wet performance deteriorated. The tire of Comparative Example 4 had a small blended amount of the silica, and thus the wear resistance performance deteriorated. The tire of Comparative Example 5 had a large blended amount of the silica, and thus the fuel economy performance deteriorated. The tire of Comparative Example 6 contained no fatty acid metal salt, and thus the wet performance and the fuel economy performance deteriorated. The tire of Comparative Example 7 contained no alkylsilane, and thus the wet performance and the fuel economy performance deteriorated.

1-7. (canceled)

8. A rubber composition for a tire, the rubber composition comprising a diene rubber, silica, a silane coupling agent, a fatty acid metal salt, and an alkylsilane;
the diene rubber containing from 60 mass % to 95 mass % of a specific conjugated diene rubber, the specific conjugated diene rubber formed by reacting a polyorganosiloxane with an active terminal of a conjugated diene-based polymer chain having the active terminal, the conjugated diene-based polymer chain formed by making a polymer block A continuous with a polymer block B, the polymer block A containing from 80 mass % to 95 mass % of isoprene and from 5 mass % to 20 mass % of aromatic vinyl, having an active terminal, and having a weight average molecular weight of from 500 to 15000, and the polymer block B containing 1,3-butadiene and an aromatic vinyl and having an active terminal; and
the silica having a CTAB adsorption specific surface area of 185 m²/g or more, and a blended amount of the silica is from 55 parts by mass to 90 parts by mass with respect to 100 parts by mass of the diene rubber.

9. The rubber composition for a tire according to claim 8, wherein the diene rubber contains from 5 mass % to 40 mass % of a polybutadiene rubber.

10. The rubber composition for a tire according to claim 8, wherein the silane coupling agent contains a tetrasulfide bond in a molecule.

11. The rubber composition for a tire according to claim 8, wherein a blended amount of the fatty acid metal salt is from 2 mass % to 8 mass % of a blended amount of the silica.

12. The rubber composition for a tire according to claim 8, wherein a blended amount of the alkylsilane is from 0.1 mass % to 20 mass % with respect to a blended amount of the silica.

13. A tire comprising:
a tread portion extending in a tire circumferential direction and having an annular shape;
a cap tread constituting a road contact surface of the tread portion; and
an undertread disposed on an inner circumferential side of the cap tread;
the cap tread containing a rubber composition for a tire according to claim 1.

14. The tire according to claim 13, wherein a hardness difference between the undertread and the cap tread in terms of JIS-A hardness is 5 or less.

15. The rubber composition for a tire according to claim 9, wherein the silane coupling agent contains a tetrasulfide bond in a molecule.

16. The rubber composition for a tire according to claim 15, wherein a blended amount of the fatty acid metal salt is from 2 mass % to 8 mass % of a blended amount of the silica.

17. The rubber composition for a tire according to claim 16, wherein a blended amount of the alkylsilane is from 0.1 mass % to 20 mass % with respect to a blended amount of the silica.

18. A tire comprising:
a tread portion extending in a tire circumferential direction and having an annular shape;
a cap tread constituting a road contact surface of the tread portion; and
an undertread disposed on an inner circumferential side of the cap tread;
the cap tread containing a rubber composition for a tire according to claim 17.

19. The tire according to claim 18, wherein a hardness difference between the undertread and the cap tread in terms of JIS-A hardness is 5 or less.
